(19) United States
(12) Patent Application Publication
(10) Pub. No.: US 2020/0334676 A1
(43) Pub. Date: Oct. 22, 2020

(54) INFORMATION RECOMMENDATION METHOD AND APPARATUS, AND MEDIUM

(71) Applicant: BEIJING BAIDU NETCOM SCIENCE AND TECHNOLOGY CO., LTD., Beijing (CN)

(72) Inventors: Yanhe WANG, Beijing (CN); Pengfei TIAN, Beijing (CN); Lingpeng FANG, Beijing (CN); Qing LI, Beijing (CN); Shuping ZHOU, Beijing (CN)

(21) Appl. No.: 16/830,043

(22) Filed: Mar. 25, 2020

(30) Foreign Application Priority Data
Apr. 18, 2019 (CN) 201910312789.7

(51) Int. Cl. G06Q 20/40; G06Q 40/02; G06Q 20/24; G06Q 20/34; G06Q 20/38

(52) U.S. Cl. CPC G06Q 20/40; G06Q 40/025; G06Q 20/389; G06Q 20/354; G06Q 20/24

(57) ABSTRACT

Embodiments of the present disclosure disclose an information recommendation method and apparatus, a device and a medium, which relate to the field of information technologies. The method includes: determining, according to a user characteristic, at least one historical user similar to a target user as a reference user; determining a target type of objects associated with historical behaviors of the reference user as candidate objects; determining weights of the candidate objects according to the historical behaviors of the reference user on the candidate objects, weights of the historical behaviors and a similarity between the reference user and the target user; and recommending the target type of objects to the target user according to the weights of the candidate objects.

### CROSS-REFERENCE TO RELATED APPLICATION

The present application is based upon and claims priority to Chinese Patent Application No. 201910312789.7, filed on Apr. 18, 2019, the entire contents of which are incorporated herein by reference.

### FIELD

Embodiments of the present disclosure relate to the field of information technologies, and more particularly, to an information recommendation method and apparatus, and a medium.

### BACKGROUND

Users' applications for credit cards feature a low application frequency and a weak characteristic. Considering the low application frequency, most users are new users. Due to a lack of historical information of the new users, the cold-boot recommendation is a tricky problem in the whole recommendation field, wherein the weak characteristic represents that it is difficult to make direct recommendations according to user attributes, and the cold-boot recommendation means that the user cannot perform the credit card recommendation according to the historical information.

In mainstream credit card application platforms, existing methods for recommending a credit card are to make recommendations based on a click rate or an income of a credit card. However, due to a personalized tendency of the users' needs, the above recommendation methods fail to satisfy personalized needs of the users.

### SUMMARY

Embodiments of the present disclosure provide an information recommendation method and apparatus, and a medium.

Embodiments of the present disclosure provide an information recommendation method, including: determining, according to a user characteristic, at least one historical user similar to a target user as a reference user; determining a target type of objects associated with historical behaviors of the reference user as candidate objects; determining weights of the candidate objects according to the historical behaviors of the reference user on the candidate objects, weights of the historical behaviors and a similarity between the reference user and the target user; and recommending the target type of objects to the target user according to the weights of the candidate objects.

Embodiments of the present disclosure provide an information recommendation apparatus, including: one or more processors; a memory storing instructions executable by the one or more processors; in which the one or more processors are configured to: determine, according to a user characteristic, at least one historical user similar to a target user as a reference user; determine a target type of objects associated with historical behaviors of the reference user as candidate objects; determine weights of the candidate objects according to the historical behaviors of the reference user on the candidate objects, weights of the historical behaviors and a similarity between the reference user and the target user; and recommend the target type of objects to the target user according to the weights of the candidate objects.

Embodiments of the present disclosure provide a computer readable storage medium having a computer program stored thereon, wherein when the program is executed by a processor, the program implements an information recommendation method according to any embodiment of the present disclosure. The information recommendation method includes: determining, according to a user characteristic, at least one historical user similar to a target user as a reference user; determining a target type of objects associated with historical behaviors of the reference user as candidate objects; determining weights of the candidate objects according to the historical behaviors of the reference user on the candidate objects, weights of the historical behaviors and a similarity between the reference user and the target user; and recommending the target type of objects to the target user according to the weights of the candidate objects.

### BRIEF DESCRIPTION OF THE DRAWINGS

FIG. 1 is a flowchart of an information recommendation method according to embodiment 1 of the present disclosure.

FIG. 2 is a flowchart of an information recommendation method according to embodiment 2 of the present disclosure.

FIG. 3 is a flowchart of an information recommendation method according to embodiment 3 of the present disclosure.

FIG. 4 is a schematic diagram of an effect of making recommendations to a new user according to a historical behavior record of an old user according to embodiment 3 of the present disclosure.

FIG. 5 is a schematic diagram of an effect of displaying user characteristics of two users with a determined similarity according to embodiment 3 of the present disclosure.

FIG. 6 is a schematic diagram of a relationship between a new user and different types of credit cards according to embodiment 3 of the present disclosure.

FIG. 7 is a schematic diagram of an information recommendation apparatus according to embodiment 4 of the present disclosure.

FIG. 8 is a schematic diagram of a device according to embodiment 5 of the present disclosure.

### DETAILED DESCRIPTION

The present disclosure will be described in detail below with reference to the accompanying drawings and the embodiments. It should be understood that, the specific embodiments described herein are only used to explain the present disclosure rather than to limit the present disclosure. In addition, it should also be noted that, for convenience of description, only part but not all structures related to the present disclosure are illustrated in the accompanying drawings.

### Embodiment 1

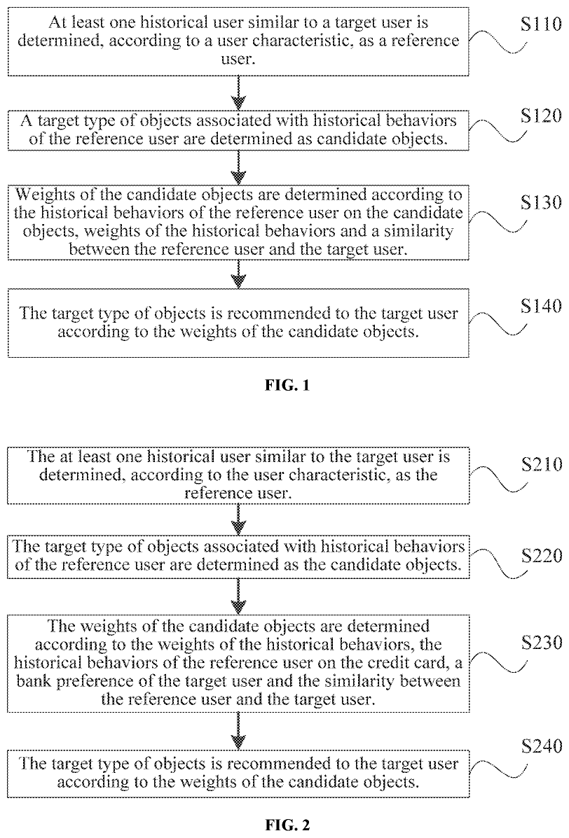

FIG. 1 is a flowchart of an information recommendation method according to embodiment 1 of the present disclosure. This embodiment is applicable to a case of recommending a target type of objects to the target user. Typically, this embodiment is applicable to a case where a credit card recommendation is made for a new user according to historical behaviors of historical users. The method may be performed by an information recommendation apparatus, and the apparatus may be implemented by software and/or hardware. Referring to FIG. 1, the information recommendation method according to this embodiment includes the following.

At block S110, at least one historical user similar to a target user is determined as a reference user according to a user characteristic.

The user characteristic refers to an attribute characteristic of the user. In detail, the user characteristic may be at least one of gender, age, interest, city, device information and bank preference of the user.

The target user is a user to be recommended with information, and may be a historical user or a new user.

The historical user refers to a user with a historical behavior record in the current application, and the new user refers to a user without a historical behavior record in the current application.

The current application may be any application, and typically, may be an application related to applying for a bank card.

Specifically, determining, according to the user characteristic, the at least one historical user similar to the target user as the reference user includes: determining similarities between the target user and historical users according to at least one of gender, age, interest, city, device information and bank preference of a user; and determining, according to the similarities, the at least one historical user similar to the target user from the historical users, to determine the at least one historical user as the reference user.

The device information refers to information on the model or operating system of the user's device. The bank preference refers to information on a bank that the user prefers.

At block S120, a target type of objects associated with historical behaviors of the reference user are determined as candidate objects.

The historical behaviors refer to behaviors carried out by the user at historical moments.

The target type of objects is a type of an object to be recommended. Specifically, the target type of objects may be any recommendable commodity, such as a credit card, a mobile phone, a computer, clothing, and the like.

The target type of objects associated with historical behaviors refers to a target type of object in objects involved in the historical behaviors.

For example, if the target type of objects refers to credit cards and the historical behaviors are applying or browsing of a credit card, the target type of objects associated with the historical behaviors is a credit card. The candidate object is a candidate credit card.

At block S130, weights of the candidate objects are determined according to the historical behaviors of the reference user on the candidate objects, weights of the historical behaviors and a similarity between the reference user and the target user.

The weights of the historical behaviors are determined according to purchasing tendencies of the candidate objects involved in the historical behaviors. The greater the purchasing tendency, the greater the weight of the historical behavior.

For example, since a purchasing tendency of a historical behavior of applying for a candidate object is greater than that of a historical behavior of browsing the candidate object, a weight of the historical behavior of applying for the candidate object is greater than that of the historical behavior of browsing the candidate object.

In detail, determining the weights of the candidate objects according to the historical behaviors of the reference user on the candidate objects, the weights of the historical behaviors and the similarity between the reference user and the target user includes: classifying the historical behaviors according to types of the candidate objects to obtain the historical behaviors of different types of the candidate objects; determining weights of the historical behaviors of each type of the candidate objects according to the weights of the historical behaviors; and performing a weighted summation on a weight of each historical behavior of each type of the candidate objects and the similarity between the reference user carrying out the historical behavior and the target user, to determine a result of the weighted summation as a weight of each type of the candidate objects.

That is, the weight of a certain type of candidate objects equals to a sum of a weight of each historical behavior of the certain type of candidate objects multiplied by a similarity between the reference user carrying out the historical behavior and the target user (i.e., the weight of a certain type of candidate objects=Σ a weight of each historical behavior of a certain type of candidate objects×a similarity between the reference user carrying out the historical behavior and the target user.

At block S140, the target type of objects is recommended to the target user according to the weights of the candidate objects.

In detail, if a weight of a candidate object is greater than a set weight threshold, the candidate object is recommended to the target user; or if a rank of the weight of a candidate object is in a preset ranking range, the candidate object is recommended to the target user.

The technical solutions of the embodiment of the present disclosure determine weights of the candidate objects according to the historical behaviors of the historical user similar to the target user, the weights of the historical behaviors and the similarity between the reference user and the target user; and recommend the target type of objects to the target user according to the weights of the candidate objects, thereby realizing personalized recommendations of credit card information to a user and improving the accuracy of information recommendation. When the new user is the target user, the problem of the cold-boot recommendation caused by a lack of historical information of the new user is also solved.

### Embodiment 2

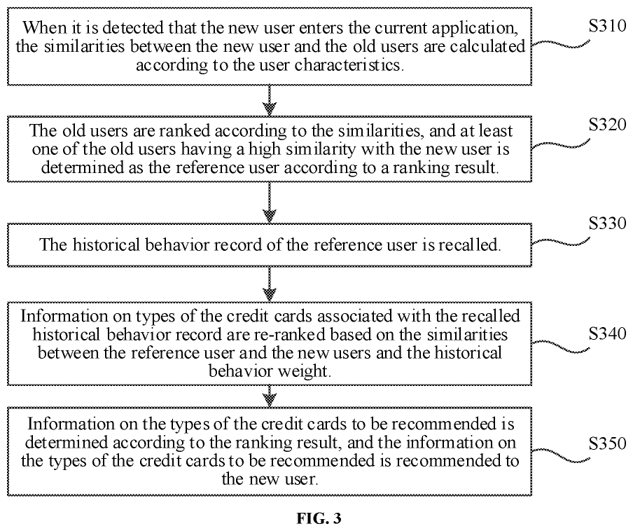

FIG. 2 is a flowchart of an information recommendation method according to embodiment 2 of the present disclosure. On the basis of the above embodiment, this embodiment provides an alternative solution by taking the target type of objects being credit cards as an example. Referring to FIG. 2, the information recommendation method according to this embodiment includes the following.

At block S210, the at least one historical user similar to the target user is determined as the reference user according to the user characteristic.

At block S220, the target type of objects associated with historical behaviors of the reference user are determined as the candidate objects.

At block S230, the weights of the candidate objects are determined according to the weights of the historical behaviors, the historical behaviors of the reference user on the credit card, a bank preference of the target user and the similarity between the reference user and the target user.

Determining the bank preference of the target user includes: determining the bank preference of the target user according to at least one of a historical search record of banks of the target user, a historical browsing record of the banks, a city where the target user is located, information on a device of the target user and information on bank application software installed in the device.

In detail, digitalization may be performed on at least one of the historical search record of the banks of the target user, the historical browsing record of the banks, the city where the target user is located, the information on the device of the target user and the information on bank application software installed in the device before performing the weighted summation; and then the bank preference of the target user is determined according to a result of the weighted summation.

Determining the weights of the candidate objects according to the weights of the historical behaviors, the historical behaviors of the reference user on the credit card, the bank preference of the target user and the similarity between the reference user and the target user includes: when the weights of at least two types of the candidate objects are determined to be the same according to the weights of the historical behaviors, the historical behaviors of the reference user on the credit card and the similarity between the reference user and the target user, and the at least two types of the candidate objects belong to different banks, adjusting the weights of the at least two types of the candidate objects according to the bank preference of the target user.

At block S240, the target type of objects is recommended to the target user according to the weights of the candidate objects.

The technical solutions of the embodiment of the present disclosure determine the weights of the candidate objects according to the weights of the historical behaviors, the historical behaviors of the reference user on the credit card, the bank preference of the target user and the similarity between the reference user and the target user, thereby further improving an accuracy rate of determining the weights of the candidate objects.

### Embodiment 3

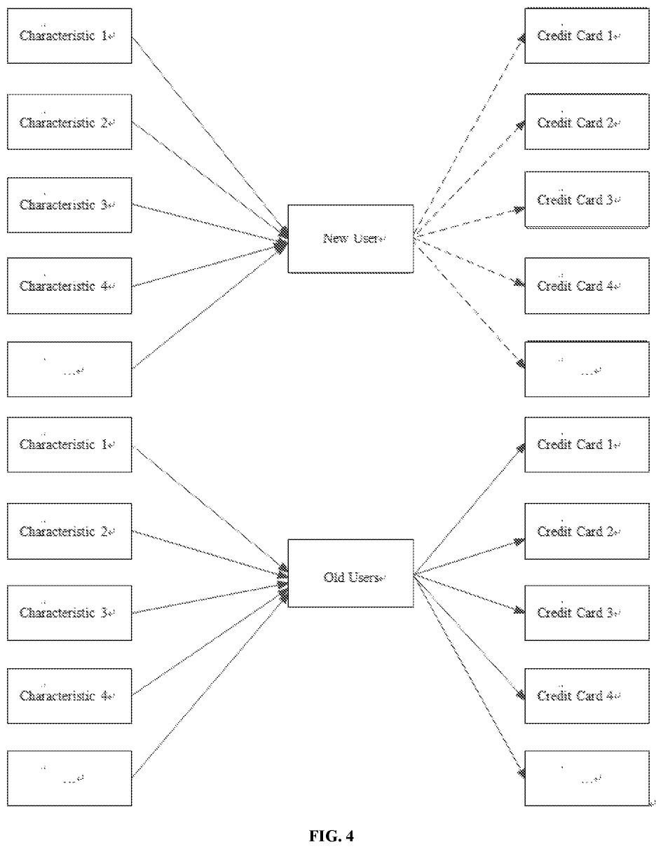

FIG. 3 is a flowchart of an information recommendation method according to embodiment 3 of the present disclosure. On the basis of the above embodiment, this embodiment provides an alternative solution by taking the target type of objects being credit cards and the target user being the new user as an example. Referring to FIG. 3, the information recommendation method according to this embodiment includes the following.

At block S310, when it is detected that the new user enters the current application, the similarities between the new user and the old users (that is, the historical users mentioned above) are calculated according to the user characteristics.

In detail, the current application is an application used to apply for a bank card.

At block S320, the old users are ranked according to the similarities, and at least one of the old users having a high similarity with the new user is determined as the reference user according to a ranking result.

At block S330, the historical behavior record of the reference user is recalled.

The historical behavior record may be a historical record of browsing credit cards, or a historical record of applying for credit cards.

At block S340, information on types of the credit cards associated with the recalled historical behavior record are re-ranked based on the similarities between the reference user and the new users and the historical behavior weight.

FIG. 4 illustrates the ranking result. Specifically, credit card 1, credit card 2, credit card 3 and credit card 4 respectively represent different types of credit cards.

Characteristic 1, characteristic 2, characteristic 3 and characteristic 4 respectively represent different types of user characteristics.

At block S350, information on the types of the credit cards to be recommended is determined according to the ranking result, and the information on the types of the credit cards to be recommended is recommended to the new user.

FIG. 4 also illustrates the specific recommendation effect. The information on the types of the credit cards in a preset ranking range is recommended to the new user according to the ranking.

The ranking reflects a need of the new user for the respective type of credit cards. The higher the ranking, the greater the new user's need for this type of credit card, and the greater the possibility of applying for the credit card, and thus the higher the success rate of recommendation.

Referring to FIG. 5, the act at block S310 specifically includes the following.

The similarities between the new user and the old users are determined according to the gender, age, interest, city, device information and bank preference of the user. The specific formula is as follows.

$${S}_{1} = \frac{\vert A ( u ) ⋂ B ( u ) \vert}{\sqrt{\vert A ( u ) \vert \vert B ( u ) \vert}} = \frac{\vert \begin{matrix}{\{ a {q}_{a} , {bq}_{b} , {cq}_{c} , {dq}_{d} , {eq}_{e} , {fq}_{f} \}}_{A} ⋂ \\ {\{ a {q}_{a} , {bq}_{b} , {cq}_{c} , {dq}_{d} , {eq}_{e} , {fq}_{f} \}}_{B}\end{matrix} \vert}{\sqrt{\begin{matrix}\vert {\{ a {q}_{a} , {bq}_{b} , {cq}_{c} , {dq}_{d} , {eq}_{e} , {fq}_{f} \}}_{A} \vert \\ \vert {\{ a {q}_{a} , {bq}_{b} , {cq}_{c} , {dq}_{d} , {eq}_{e} , {fq}_{f} \}}_{B} \vert\end{matrix}}}$$

where a, b, c, d, e and f respectively represent different user characteristics, qₐ, q_{b}, q_{c}, q_{d}, qₑ and of respectively represent the weight of each user characteristic, {aqₐ, bq_{b}, cq_{c}, dq_{d}, eqₑ, fq_{f}}_{A} represents a user characteristic vector of user A, and {aqₐ, bq_{b}, cq_{c}, dq_{d}, eqₑ, fq_{f}}_{B} identifies a user characteristic vector of user B.

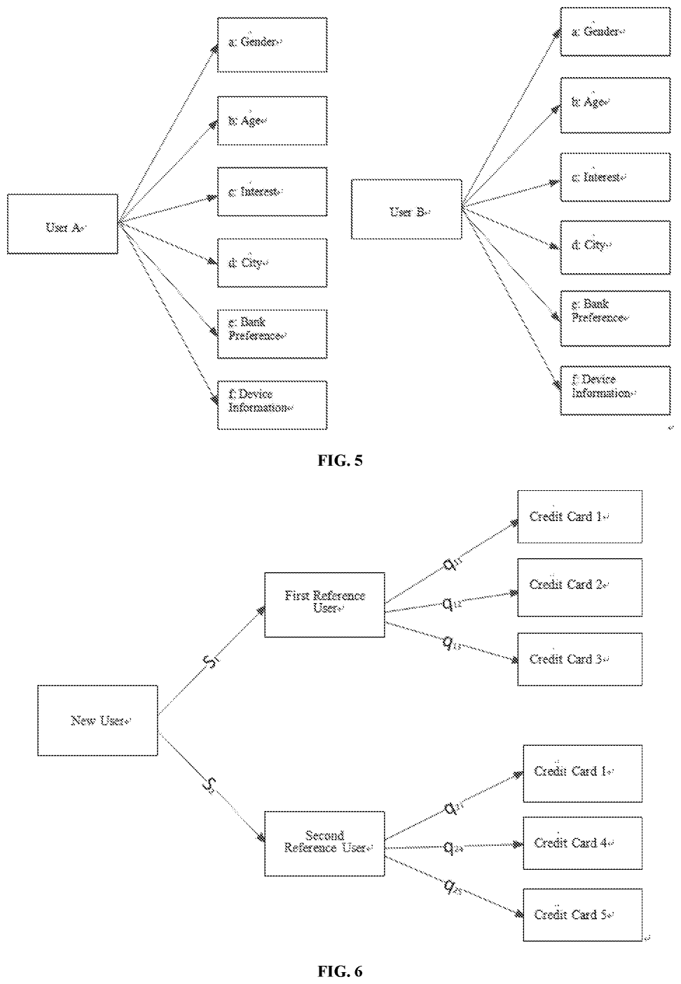

Referring to FIG. 6, the act at block S340 specifically includes the following.

The weight of each type of credit cards associated with the historical behavior record is calculated according to the following formula:

weightⱼ=ΣSᵢqᵢⱼ

where weightⱼ refers to a weight of a credit card i, Sᵢ refers to a similarity between the new user and the i^{th} reference user, and qᵢⱼ refers to a historical behavior weight of the i^{th} reference user on the credit card i.

For example, the weight of the credit card 1 in FIG. 6 is:

weight₁=S₁q₁₁+S₂q₂₁

Various types of credit cards are ranked by the weights.

The technical solutions of the embodiment of the present disclosure solve a problem of making personalized recommendations on credit cards, select different credit cards for different users, greatly shorten a path for users to find a card, increase the efficiency of card application, and improve the user experience.

In addition, since personalized recommendations are made, it is easier for users to find a desired credit card, such that the click rate of credit cards and the efficiency of the entire business realization are increased.

It should be noted that, with the technical teaching of this embodiment, those skilled in the art have a motivation to make a combination of any of the implementation methods described in the above embodiments, so as to implement personalized recommendations on credit cards and to solve a problem of a cold-boot recommendation of the new user.

### Embodiment 4

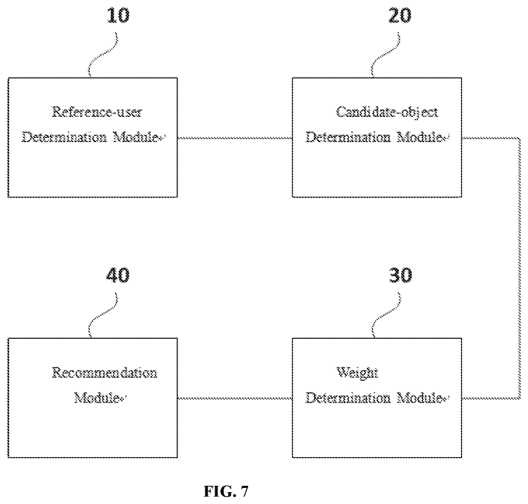

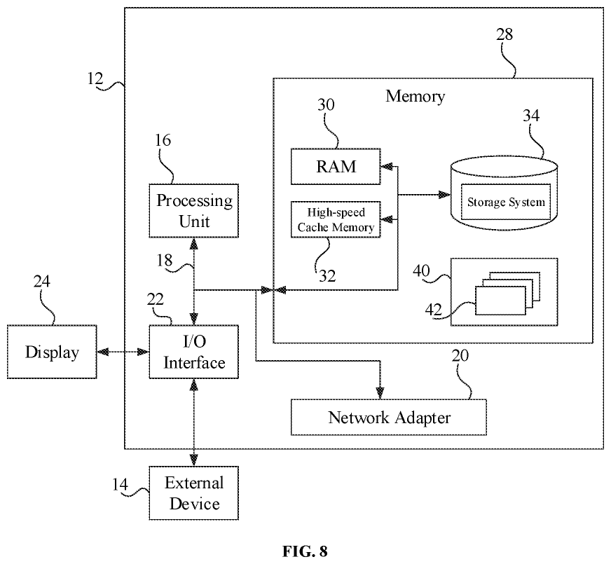

FIG. 7 is a schematic diagram of an information recommendation apparatus according to embodiment 4 of the present disclosure. Referring to FIG. 7, the information recommendation method according to this embodiment includes: a reference-user determination module 10, a candidate-object determination module 20, a weight determination module 30 and a recommendation module 40.

The reference-user determination module 10 is configured to determine, according to the user characteristic, at least one historical user similar to the target user as the reference user.

The candidate-object determination module 20 is configured to determine the target type of objects associated with historical behaviors of the reference user as the candidate objects.

The weight determination module 30 is configured to determine the weights of the candidate objects according to the historical behaviors of the reference user on the candidate objects, the weights of the historical behaviors and the similarity between the reference user and the target user.

The recommendation module 40 is configured to recommend the target type of objects to the target user according to the weights of the candidate objects.

The embodiment of the present disclosure determines weights of the candidate objects according to the historical behaviors of the historical user similar to the target user, the weights of the historical behaviors and the similarity between the reference user and the target user; and recommends the target type of objects to the target user according to the weights of the candidate objects, thereby realizing personalized recommendations of credit card information to the user and improving the accuracy of information recommendation. When the new user is the target user, the problem of the cold-boot recommendation caused by a lack of historical information of the new user is also solved.

Further, the weight determination module includes: a behavior classification unit, a behavior-weight determination unit and an object-weight determination unit.

The behavior classification unit is configured to classify the historical behaviors according to the types of the candidate objects to obtain the historical behaviors of the different types of the candidate objects.

The behavior-weight determination unit is configured to determine the weights of the historical behaviors of each type of the candidate objects according to the weights of the historical behaviors.

The object-weight determination unit is configured to perform the weighted summation on the weight of each historical behavior of each type of the candidate objects and the similarity between the reference user carrying out the historical behavior and the target user, to determine the result of the weighted summation as the weight of each type of the candidate objects.

Further, when the target type of objects is a credit card, the weight determination module includes: a weight determination unit.

The weight determination unit is configured to determine the weights of the candidate objects according to the weights of the historical behaviors, the historical behaviors of the reference user on the credit card, the bank preference of the target user and the similarity between the reference user and the target user.

Further, the weight determination unit is configured to: when the weights of at least two types of the candidate objects are determined to be the same according to the weights of the historical behaviors, the historical behaviors of the reference user on the credit card and the similarity between the reference user and the target user, and the at least two types of the candidate objects belong to different banks, adjust the weights of the at least two types of the candidate objects according to the bank preference of the target user.

Further, the apparatus includes: a bank-preference determination module.

The bank-preference determination module is configured to determine the bank preference of the target user according to at least one of the historical search record of the banks of the target user, the historical browsing record of the banks, the city where the target user is located, information on the device of the target user and information on the bank application software installed in the device.

Further, the reference-user determination module includes: a similarity determination unit and a reference-user determination unit.

The similarity determination unit is configured to determine similarities between the target user and the historical users according to the at least one of the gender, age, interest, city, device information and bank preference of the user.

The reference-user determination unit is configured to determine, according to the similarities, the at least one historical user similar to the target user from the historical users, to determine the at least one historical user as the reference user.

The information recommendation apparatus according to the embodiment of the present disclosure may execute the information recommendation method according to any embodiment of the present disclosure, and has function modules and beneficial effects corresponding to executing the method.

### Embodiment 5

FIG. 8 is a schematic diagram of a device according to embodiment 5 of the present disclosure. FIG. 8 is a block diagram of an exemplary device 12 applicable for implementing embodiments of the present disclosure. The device 12 illustrated in FIG. 8 is only illustrated as an example, and should not be considered as any restriction on the function and the usage range of embodiments of the present disclosure.

As illustrated in FIG. 8, the device 12 is in the form of a general-purpose computing apparatus. The device 12 may include, but is not limited to, one or more processors or processing units 16, a system memory 28, and a bus 18 connecting different system components (including the system memory 28 and the processing unit 16).

The bus 18 represents one or more of several types of bus architectures, including a memory bus or a memory control bus, a peripheral bus, a graphic acceleration port (GAP) bus, a processor bus, or a local bus using any bus architecture in a variety of bus architectures. For example, these architectures include, but are not limited to, an industry standard architecture (ISA) bus, a micro-channel architecture (MCA) bus, an enhanced ISA bus, a video electronic standards association (VESA) local bus, and a peripheral component interconnect (PCI) bus.

Typically, the device 12 may include multiple kinds of computer-readable media. These media may be any storage media accessible by the device 12, including transitory or non-transitory storage medium and movable or unmovable storage medium.

The memory 28 may include a computer-readable medium in a form of volatile memory, such as a random access memory (RAM) 30 and/or a high-speed cache memory 32. The device 12 may further include other transitory/non-transitory storage media and movable/unmovable storage media. In way of example only, the storage system 34 may be configured to read and write non-removable, non-volatile magnetic media (not shown in the figure, commonly referred to as “hard disk drives”). Although not illustrated in FIG. 8, it may be provided a disk driver for reading and writing movable non-volatile magnetic disks (e.g. “floppy disks”), as well as an optical driver for reading and writing movable non-volatile optical disks (e.g. a compact disc read only memory (CD-ROM, a digital video disc read only Memory (DVD-ROM), or other optical media). In these cases, each driver may be connected to the bus 18 via one or more data medium interfaces. The memory 28 may include at least one program product, which has a set of (for example at least one) program modules configured to perform the functions of embodiments of the present disclosure.

A program/application 40 with a set of (at least one) program modules 42 may be stored in memory 28, the program modules 42 may include, but not limit to, an operating system, one or more application programs, other program modules and program data, and any one or combination of above examples may include an implementation in a network environment. The program modules 42 are generally configured to implement functions and/or methods described in embodiments of the present disclosure.

The device 12 may also communicate with one or more external devices 14 (e.g., a keyboard, a pointing device, a display 24, and etc.) and may also communicate with one or more devices that enables a user to interact with the computer system/device 12, and/or any device (e.g., a network card, a modem, and etc.) that enables the computer system/device 12 to communicate with one or more other computing devices. This kind of communication can be achieved by the input/output (I/O) interface 22. In addition, the device 12 may be connected to and communicate with one or more networks such as a local area network (LAN), a wide area network (WAN) and/or a public network such as the Internet through a network adapter 20. As shown in FIG. 8, the network adapter 20 communicates with other modules of the device 12 over bus 18. It should be understood that although not shown in the figure, other hardware and/or software modules may be used in combination with the device 12, which including, but not limited to, microcode, device drivers, redundant processing units, external disk drive arrays, RAID systems, tape drives, as well as data backup storage systems and the like.

The processing unit 16 can perform various functional applications and data processing by running programs stored in the system memory 28, for example, to perform the information recommendation method according to the embodiments of the present disclosure.

### Embodiment 6

Embodiment 6 of the present disclosure further provides a computer readable storage medium having a computer program stored thereon. When the program is executed by a processor, the program implements the information recommendation method according to any one of the embodiments of the present disclosure. The method includes: determining, according to a user characteristic, at least one historical user similar to a target user as a reference user; determining a target type of objects associated with historical behaviors of the reference user as candidate objects;

determining weights of the candidate objects according to the historical behaviors of the reference user on the candidate objects, weights of the historical behaviors and a similarity between the reference user and the target user; and recommending the target type of objects to the target user according to the weights of the candidate objects. The computer storage medium proposed by embodiments of the present disclosure may adopt any combination of one or more computer readable media. The computer readable medium may be a computer readable signal medium or a computer readable storage medium. The computer readable storage medium may be, but is not limited to, for example, an electrical, magnetic, optical, electromagnetic, infrared, or semiconductor system, apparatus, device, component or any combination thereof. A specific example of the computer readable storage media include (a non-exhaustive list): an electrical connection having one or more wires, a portable computer disk, a hard disk, a random access memory (RAM), a read only memory (ROM), an Erasable Programmable Read Only Memory (EPROM) or a flash memory, an optical fiber, a compact disc read-only memory (CD-ROM), an optical memory component, a magnetic memory component, or any suitable combination thereof. In context, the computer readable storage medium may be any tangible medium including or storing programs. The programs may be used by an instruction executed system, apparatus or device, or a connection thereof. The computer readable signal medium may include a data signal propagating in baseband or as part of carrier which carries a computer readable program codes. Such propagated data signal may be in many forms, including but not limited to an electromagnetic signal, an optical signal, or any suitable combination thereof. The computer readable signal medium may also be any computer readable medium other than the computer readable storage medium, which may send, propagate, or transport programs used by an instruction executed system, apparatus or device, or a connection thereof.

The program code stored on the computer readable medium may be transmitted using any appropriate medium, including but not limited to wireless, wire line, optical fiber cable, RF, or any suitable combination thereof.

The computer program code for carrying out operations of embodiments of the present disclosure may be written in one or more programming languages. The programming language includes an object oriented programming language, such as Java, Smalltalk, C++, as well as conventional procedural programming language, such as “C” language or similar programming language. The program code may be executed entirely on a user's computer, partly on the user's computer, as a separate software package, partly on the user's computer, partly on a remote computer, or entirely on the remote computer or server. In a case of the remote computer, the remote computer may be connected to the user's computer or an external computer (such as using an Internet service provider to connect over the Internet) through any kind of network, including a Local Area Network (hereafter referred as to LAN) or a Wide Area Network (hereafter referred as to WAN).

It should be noted that, the above are only preferred embodiments and applied technical principles of the present disclosure. Those skilled in the art should understand that, the present disclosure is not limited to the specific embodiments described herein, and various obvious changes, readjustments and substitutions that are made by those skilled in the art will not depart from the scope of the present disclosure. Therefore, although the present disclosure has been described in detail by the above embodiments, the present disclosure is not limited to the above embodiments, and more other equivalent embodiments may be included without departing from the concept of the present disclosure, and the scope of the present disclosure is determined by the scope of the appended claims.

What is claimed is:

1. An information recommendation method, comprising:
determining, according to a user characteristic, at least one historical user similar to a target user as a reference user;
determining a target type of objects associated with historical behaviors of the reference user as candidate objects;
determining weights of the candidate objects according to the historical behaviors of the reference user on the candidate objects, weights of the historical behaviors and a similarity between the reference user and the target user; and
recommending the target type of objects to the target user according to the weights of the candidate objects.

2. The method of claim 1, wherein determining the weights of the candidate objects according to the historical behaviors of the reference user on the candidate objects, the weights of the historical behaviors and the similarity between the reference user and the target user comprises:
classifying the historical behaviors according to types of the candidate objects to obtain the historical behaviors of different types of the candidate objects;
determining weights of the historical behaviors of each type of the candidate objects according to the weights of the historical behaviors; and
performing a weighted summation on a weight of each historical behavior of each type of the candidate objects and the similarity between the reference user carrying out the historical behavior and the target user, to determine a result of the weighted summation as a weight of each type of the candidate objects.

3. The method of claim 1, wherein when the target type of objects is a credit card, determining the weights of the candidate objects according to the historical behaviors of the reference user on the candidate objects, the weights of the historical behaviors and the similarity between the reference user and the target user comprises:
determining the weights of the candidate objects according to the weights of the historical behaviors, the historical behaviors of the reference user on the credit card, a bank preference of the target user and the similarity between the reference user and the target user.

4. The method of claim 3, wherein determining the weights of the candidate objects according to the weights of the historical behaviors, the historical behaviors of the reference user on the credit card, the bank preference of the target user and the similarity between the reference user and the target user comprises:
when the weights of at least two types of the candidate objects are determined to be the same according to the weights of the historical behaviors, the historical behaviors of the reference user on the credit card and the similarity between the reference user and the target user, and the at least two types of the candidate objects belong to different banks, adjusting the weights of the at least two types of the candidate objects according to the bank preference of the target user.

5. The method of claim 3, wherein determining the bank preference of the target user comprises:
determining the bank preference of the target user according to at least one of a historical search record of banks of the target user, a historical browsing record of the banks, a city where the target user is located, information on a device of the target user and information on bank application software installed in the device.

6. The method of claim 1, wherein determining, according to the user characteristic, the at least one historical user similar to the target user as the reference user comprises:
determining similarities between the target user and historical users according to at least one of gender, age, interest, city, device information and bank preference of a user; and
determining, according to the similarities, the at least one historical user similar to the target user from the historical users, to determine the at least one historical user as the reference user.

7. An information recommendation apparatus, comprising:
one or more processors;
a memory storing instructions executable by the one or more processors;
wherein the one or more processors are configured to:
determine, according to a user characteristic, at least one historical user similar to a target user as a reference user;
determine a target type of objects associated with historical behaviors of the reference user as candidate objects;
determine weights of the candidate objects according to the historical behaviors of the reference user on the candidate objects, weights of the historical behaviors and a similarity between the reference user and the target user; and
recommend the target type of objects to the target user according to the weights of the candidate objects.

8. The apparatus of claim 7, wherein the one or more processors are configured to:
classify the historical behaviors according to types of the candidate objects to obtain the historical behaviors of different types of the candidate objects;
determine weights of the historical behaviors of each type of the candidate objects according to the weights of the historical behaviors; and
perform a weighted summation on a weight of each historical behavior of each type of the candidate objects and the similarity between the reference user carrying out the historical behavior and the target user, to determine a result of the weighted summation as a weight of each type of the candidate objects.

9. The apparatus of claim 7, wherein when the target type of objects is a credit card, the one or more processors are configured to:
determine the weights of the candidate objects according to the weights of the historical behaviors, the historical behaviors of the reference user on the credit card, a bank preference of the target user and the similarity between the reference user and the target user.

10. The apparatus of claim 9, wherein the one or more processors are configured to:
when the weights of at least two types of the candidate objects are determined to be the same according to the weights of the historical behaviors, the historical behaviors of the reference user on the credit card and the similarity between the reference user and the target user, and the at least two types of the candidate objects belong to different banks, adjust the weights of the at least two types of the candidate objects according to the bank preference of the target user.

11. The apparatus of claim 9, wherein the one or more processors are configured to:
determine the bank preference of the target user according to at least one of a historical search record of banks of the target user, a historical browsing record of the banks, a city where the target user is located, information on a device of the target user and information on bank application software installed in the device.

12. The apparatus of claim 7, wherein the one or more processors are configured to:
determine similarities between the target user and historical users according to at least one of gender, age, interest, city, device information and bank preference of a user; and
determine, according to the similarities, the at least one historical user similar to the target user from the historical users, to determine the at least one historical user as the reference user.

13. A computer readable storage medium having a computer program stored thereon, wherein when the program is executed by a processor, the program implements an information recommendation method, and the method comprises:
determining, according to a user characteristic, at least one historical user similar to a target user as a reference user;
determining a target type of objects associated with historical behaviors of the reference user as candidate objects;
determining weights of the candidate objects according to the historical behaviors of the reference user on the candidate objects, weights of the historical behaviors and a similarity between the reference user and the target user; and
recommending the target type of objects to the target user according to the weights of the candidate objects.
